(19) United States
(12) Patent Application Publication
(10) Pub. No.: US 2008/0184125 A1
(43) Pub. Date: Jul. 31, 2008

(54) SYSTEM AND METHOD FOR EXTENDING WEB-BASED STORAGE TO A LOCAL OPERATING SYSTEM GRAPHICAL USER INTERFACE

(76) Inventors: Mohammad Suleiman, Trabuco Canyon, CA (US); Hongfeng Wei, Anaheim, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/669,793

(22) Filed: Jan. 31, 2007

(51) Int. Cl. G06F 15/177

(52) U.S. Cl. 715/734

(57) ABSTRACT

The subject application is directed to a system and method for integration of web-based storage to a local operating system graphical user interface. A workstation detects a remote storage location via a network interface and stores login data to access the remote storage location. Identification data is then communicated to the storage. A display window of the user interface of the workstation is generated to reflect the remote storage. File instructions, which interact with the operating system of the workstation, are received via the user interface and communicated to the remote storage. Status data is received from the remote data storage via the computer network, and status display data is generated on the user interface. Communication is selectively commenced of a data file between the workstation and the remote data storage according to data transfer instructions. The remote data storage location is mapped, appearing as local storage on the workstation.

### BACKGROUND OF THE INVENTION

The subject application is directed to a system and method for integration of web-based storage to a local operating system graphical user interface. In particular, the subject application is directed to a system and method for remote data storage systems to be more seamlessly integrated into a workstation interface.

Ubiquitous, high-bandwidth wide area networking, including the global Internet, coupled with the advent of inexpensive data storage devices, has given rise to the availability of remote data storage systems. Earlier remote storage systems included FTP (file transfer protocol) sites, which were typically accessible via Unix-based text interfaces, including typed file operation and transfer commands, such as “put” and “get.” While effective, such systems were difficult to use. For example, a user would first have to specify whether a transfer was binary, for files such as executables, or ASCII based, such as with text files. More recently, remote file storage systems could be more easily accessed from a desktop interface of a networked workstation by use of a browser, such as INTERNET EXPLORER, MOZILLA, or OPERA.

Still more recently, commercial services have arisen which allow users to upload, download, and manipulate data remotely, such as via the Web. These systems are useful for backup, archiving, file sharing and allowing users access to data from a different computers or locations. Such storage services may be fee based, private, or provided by public institutions. However, such remote storage systems require users to open a web browser, login to a site, and commence operations through a non-standard or cumbersome web interface.

### SUMMARY OF THE INVENTION

In accordance with one embodiment of the subject application, there is provided a system and method for integration of web-based storage to a local operating system graphical user interface.

Further, in accordance with one embodiment of the subject application, there is provided a system and method that allows for remote data storage systems to be more seamlessly integrated into a workstation interface.

Still further, in accordance with one embodiment of the subject application, there is provided a system and method wherein a remote storage facility is integrated into a workstation such that it appears to a user to be a local storage, such as a local hard drive.

Further, in accordance with one embodiment of the subject application, there is provided a system for integration of web-based storage to a local operating system graphical user interface. The system includes a driver adapted for installation on an associated workstation and mapping means adapted for mapping at least one remote data storage location so as to appear as a local data storage. The driver includes means adapted for detecting availability of at least one remote data storage location accessible to the associated workstation via an associated network interface and means adapted for storing login data corresponding to access of the at least one remote data storage. The driver further includes means adapted for communicating identification data corresponding to the login data to the at least one remote data storage so as to allow data interchange therewith and means adapted for generating a user interface corresponding to the at least one remote data storage on a display window of the associated workstation. The driver also includes means adapted for receiving from an associated user, via a generated user interface, file operation instructions and file transfer instructions and means adapted for communicating file operation data corresponding to received file operation instructions to the at least one remote data storage. The driver further comprises means adapted for receiving status data from the at least one remote data storage via the associated network interface and means adapted for generating status display data corresponding to received status data on the user interface. The driver also comprises means adapted for selectively commencing a communication of at least one data file between the associated workstation and the at least one remote data storage in accordance with data transfer instructions received via the user interface. In the system, at least one of file operation instructions and file transfer instructions are integrated so as to interact with a user interface associated with an operating system disposed on the associated workstation such that the at least one remote data storage appears to be a local storage associated with the workstation.

In one embodiment of the subject application, the driver further comprises means adapted for generating the file operation instruction data from received file operation instructions in web services communication protocol format and means adapted for receiving the status data in web services communications protocol format.

In another embodiment of the subject application, the file operation instructions include at least one operation from the set comprising view, copy, move, delete, create, and rename.

In yet another embodiment of the subject application, the web services communication protocol format is a SOAP format.

In a further embodiment of the subject application, the mapping means includes means adapted for mapping the at least one remote data storage as a logical disk drive associated with the workstation.

In still a further embodiment of the subject application, the status data includes data representative of at least one data from the set comprising storage capacity, storage utilization, remaining capacity, storage cost, elapsed storage time, file size, storage location, and storage provider.

Still further, in accordance with one embodiment of the subject application, there is provided a method for integration of web-based storage to a local operating system graphical user interface in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for integration of web-based storage to a local operating system graphical user interface according to one embodiment of the subject application;

FIG. 2 is a block diagram illustrating controller hardware for use in the system for integration of web-based storage to a local operating system graphical user interface according to one embodiment of the subject application;

FIG. 3 is a functional diagram illustrating the controller for use in the system for integration of web-based storage to a local operating system graphical user interface according to one embodiment of the subject application;

FIG. 4 is a block diagram illustrating a workstation for use in the system for integration of web-based storage to a local operating system graphical user interface according to one embodiment of the subject application;

FIG. 5 is a block diagram illustrating a server for use in the system for integration of web-based storage to a local operating system graphical user interface according to one embodiment of the subject application;

FIG. 6 is a flowchart illustrating a method for integration of web-based storage to a local operating system graphical user interface according to one embodiment of the subject application;

FIG. 7 is a flowchart illustrating a method for integration of web-based storage to a local operating system graphical user interface from a workstation perspective according to one embodiment of the subject application;

FIG. 8 is a flowchart illustrating a method for integration of web-based storage to a local operating system graphical user interface from a storage perspective according to one embodiment of the subject application.

### DETAILED DESCRIPTION OF THE PREFERRED EMBODIMENT

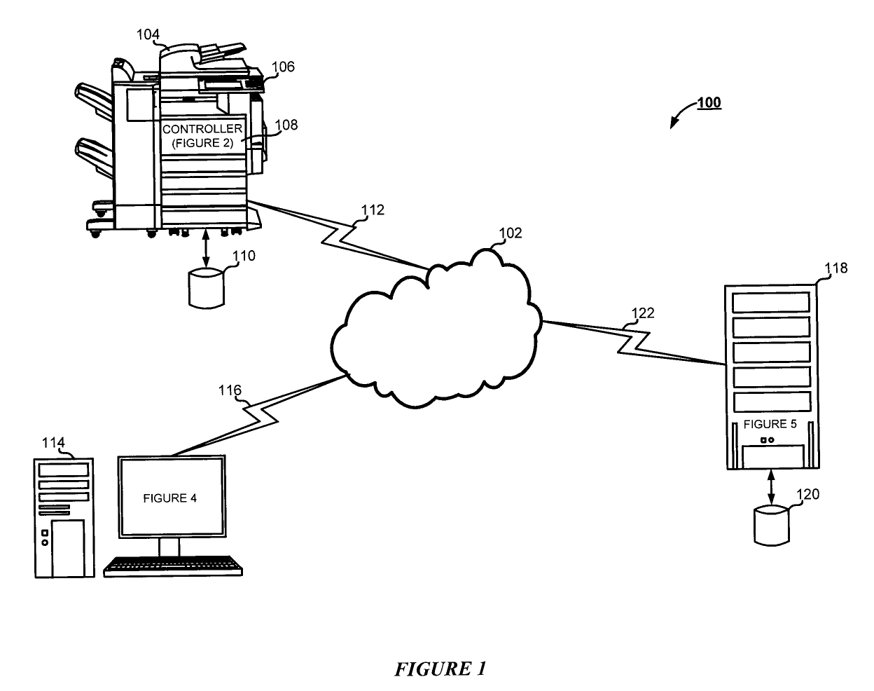

The subject application is directed to a system and method for integration of web-based storage to a local operating system graphical user interface. In particular, the subject application is directed to a system and method that allows for remote data storage systems to be more seamlessly integrated into a workstation interface. More particularly, the subject application is directed to a system and method wherein a remote storage facility is integrated into a workstation such that it appears to a user to be a local storage, such as a local hard drive. It will become apparent to those skilled in the art that the system and method described herein are suitably adapted to a plurality of varying electronic fields employing remote storage, including, for example and without limitation, communications, general computing, data processing, document processing, or the like. The preferred embodiment, as depicted in FIG. 1, illustrates a network data storage field for example purposes only and is not a limitation of the subject application solely to such a field.

Referring now to FIG. 1, there is shown an overall diagram of the system 100 for integration of web-based storage to a local operating system graphical user interface. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

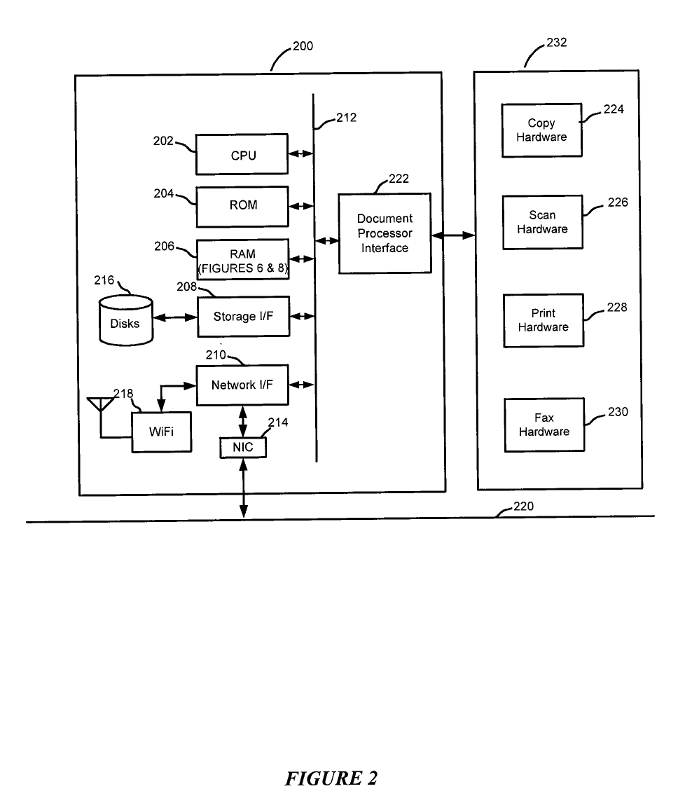

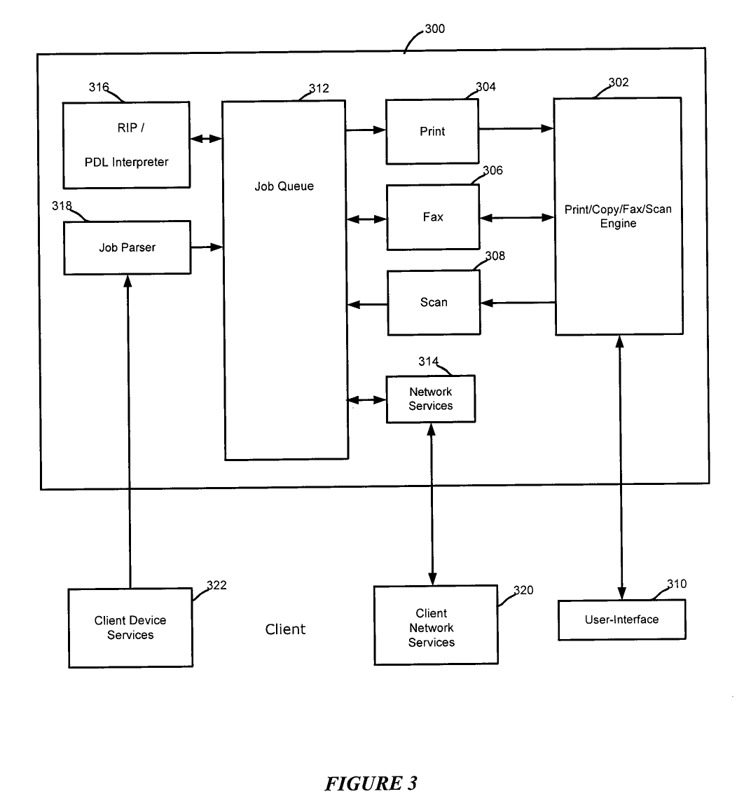

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for integration of web-based storage to a local operating system graphical user interface of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data storage device 110 includes electronic data representative of image data, document data, multimedia data, or the like, corresponding to an associated user. Preferably, the data storage device 110 is capable of viewing and interaction with a user via a local operating system associated with a remote electronic device.

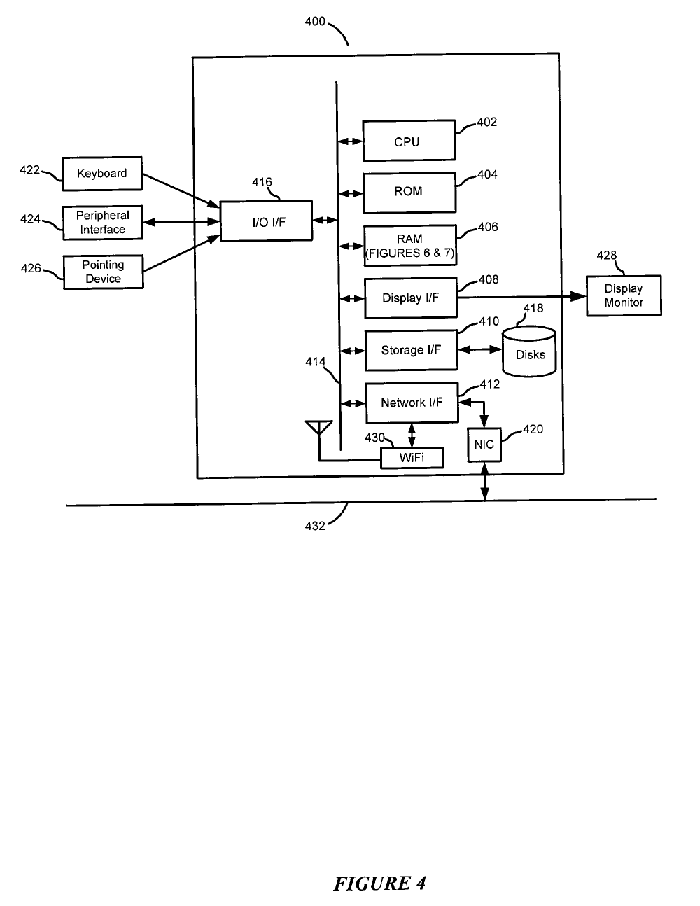

The system 100 illustrated in FIG. 1 further depicts a workstation 114, in data communication with the computer network 102 via a communications link 116. It will be appreciated by those skilled in the art that the workstation 114 is shown in FIG. 1 as a workstation for illustration purposes only. As will be understood by those skilled in the art, the workstation 114 is representative of any computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 114 is suitably adapted to generate and transmit electronic documents, document processing instructions, user interface modifications, upgrades, updates, personalization data, or the like, to the document processing device 104, the network storage server 118 or any other similar device coupled to the computer network 102. In accordance with one embodiment of the subject application, the workstation 114 is suitably adapted to run a plurality of file management, search, and modification applications. The operation of the workstation 114 will better be understood in conjunction with the block diagram illustrated in FIG. 4, explained in greater detail below.

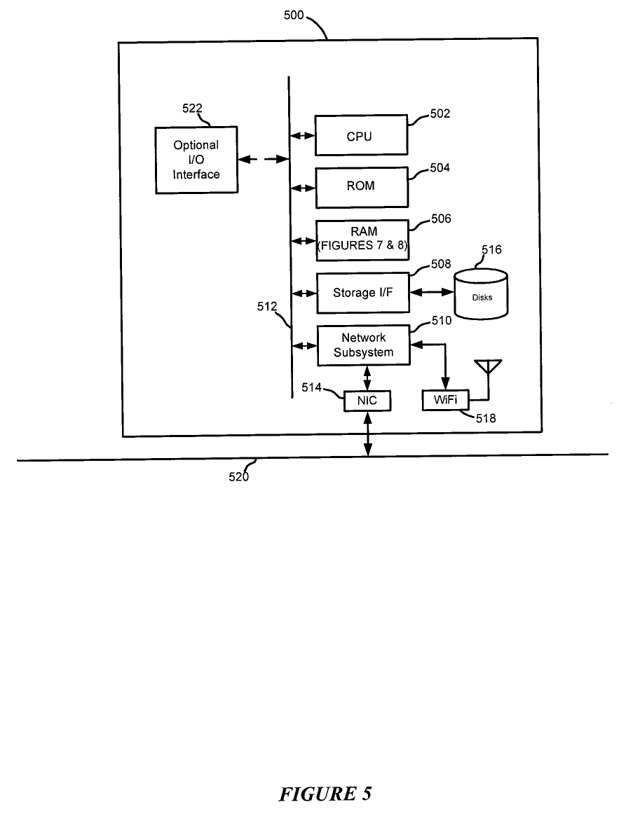

The system 100 further illustrates a network storage server 118 coupled to a data storage device 120. Preferably, the network storage server 118 is representative of any network storage device known in the art capable of storing document data, image data, video data, sound data, multimedia data, or other suitable electronic data, as will be known in the art. In accordance with one embodiment of the subject application, the data storage device 120 includes a plurality of electronic data, including image data, document data, or the like. The network storage server 118 is communicatively coupled to the computer network 102 via a suitable communications link 122. As will be understood by those skilled in the art, the communications link 122 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art. The operation of the network storage server 118 will be better understood in conjunction with the block diagram illustrated in FIG. 5, explained in greater detail below.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image processor, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the workstation computer 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

Referring now to FIG. 5, illustrated is a representative architecture of a suitable server 500, shown in FIG. 1 as the network storage server 118, on which operations of the subject system are completed. Included is a processor 502, suitably comprised of a central processor unit. However, it will be appreciated that the processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration, and other routines or data used for operation of the server 500.

Also included in the server 500 is random access memory 506, suitably formed of dynamic random access memory, static random access memory, or any other suitable, addressable memory system. Random access memory provides a storage area for data instructions associated with applications and data handling accomplished by the processor 502.

A storage interface 508 suitably provides a mechanism for volatile, bulk or long term storage of data associated with the server 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the server 500 to communicate to other devices. The network interface subsystem 510 suitably interfaces with one or more connections with external devices to the server 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network subsystem 510 is suitably accomplished via a bus data transfer mechanism, such as illustrated by bus 512.

Suitable executable instructions on the server 500 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 522 as will be appreciated by one of ordinary skill in the art.

In operation, an accessible remote storage location is first detected by a workstation via a computer network interface. Login data, corresponding to access of the remote data storage, is then stored. Identification data, corresponding to the stored login data, is then communicated to the remote data storage. Preferably, the identification data enables the interchange of data between the workstation and the remote data storage location. A user interface is then generated on a display window of the workstation corresponding to the remote data storage location. File operation instructions and file transfer instructions are then received from an associated user via the generated user interface. The file operation data, corresponding to the received file operation instructions, is then communicated to the remote data storage. Status data is then received from the remote data storage via the computer network. Status display data is then generated on the user interface corresponding to the received status data. Communication is then selectively commenced of a data file between the associated workstation and the remote data storage according to the data transfer instructions received via the user interface. The remote data storage location is then mapped so as to appear as a local data storage on the associated workstation. Preferably, the file operation instructions and file transfer instructions are integrated so as to interact with the user interface associated with the operating system on the workstation. Thus, the remote data storage appears as a local storage associated with the workstation.

In accordance with one example embodiment of the subject application, a client driver is first installed on a computer workstation 114 as will be understood by those skilled in the art. Preferably, the client driver is suitably adapted to interface with a network interface coupled to the computer network 102. More preferably, the client driver is capable of interacting with the operating system resident on the computer workstation 114. The workstation 114, via the driver, then detects at least one accessible remote data storage device, e.g., the data storage device 110 coupled to the document processing device 104, the data storage device 120 coupled to the network storage server 118, or the like. The client driver on the workstation 114 then determines whether authentication is required. That is, the driver determines whether a username and/or password are required by the accessible data storage device 110 or 120 in order to perform actions thereon. When authentication data is required, the client driver prompts an associated user, via a user interface associated with the workstation 114 for the appropriate login information. Identification data, corresponding to the received login data, is then communicated via the computer network 102 to the remote data storage device 110 or 120. In accordance with one embodiment of the subject application, the identification data is communicated via the computer network 102 using a suitable security protocol, as are known in the art. The skilled artisan will appreciate that the identification data is also capable of being transmitted via the computer network 102 in an encrypted format, so as to secure the identification data against unauthorized or accidental interception by a third-party.

An authentication token is then received from the designated remote storage device 110 or 120, which is then stored locally on the workstation 114. It will be understood by those skilled in the art that the receipt of the token thereby enables subsequent communications with the remote storage device 110 or 120 without requiring reentry of the login data. The remote storage device 110 or 120 is then mapped as a logical disk drive associated with the workstation 114. That is, the client driver directs the operating system of the workstation 114 to recognize the remote storage device 110 or 120 as a local disk drive. It will be understood by those skilled in the art that when authentication is not required, or when a token is already stored locally on the workstation 114, the client driver directs the operating system to map the remote data storage device 110 or 120 as a local or logical disk drive associated with the workstation 114. Accordingly, the client driver then directs the generation of a user interface representing the remote data storage device 110 or 120 on the workstation 114. It will be understood by those skilled in the art that such a user interface is capable of including, for example and without limitation, an icon representative of the remote storage device 110 or 120 in the operating system of the workstation 114.

When file operation instructions, or file transfer instructions are received from the associated user via the workstation 114, the client driver generates file operation instruction data from the file operation instructions in a web services communication protocol format. Preferably, the client driver generates a Simple Object Access Protocol (“SOAP”) format request. As will be understood by those skilled in the art, the SOAP message format is preferably an XML message containing a file operation request that is understood by the remote storage device 110 or 120. Suitable file operation instructions include, for example and without limitation, a view operation, a copy operation, a move operation, a delete operation, a create operation, a rename operation, or the like. An example XML SOAP message requesting a copy operation is illustrated below:

```
<?xml version=“1.0” encoding=“UTF-8”?>
<SOAP-ENV:Envelope xmlns:SOAP-ENV=“http://www.w3.org/2003/05/soap-
envelope”
          xmlns:SOAP-ENC=“http://www.w3.org/2003/05/soap-encoding”
          xmlns:xsi=“http://www.w3.org/2001/XMLSchema-instance”
          xmlns:xsd=“http://www.w3.org/2001/XMLSchema”
xmlns:wsdiscmap=“http://schemas.toshiba.com/ws/2006/08/webdiscmapping”
          xmlns:wss=“http://schemas.xmlsoap.org/ws/2005/08/Security”
          xmlns:wsa=“http://schemas.xmlsoap.org/ws/2004/08/Address”
          xmlns:wsc=“http://schemas.xmlsoap.org/ws/2004/08/Compression”
          xmlns:wse=“http://schemas.xmlsoap.org/ws/2005/04/Eventing”
xmlns:wsr=“http://schemas.xmlsoap.org/ws/2004/09/ReliableMessaging”>
  <SOAP-ENV:Header>
    <wsa:Action>
      http://schemas.toshiba.com/windows/2006/08/webdiskmapping/CopyRequest
    </wsa:Action>
    <wsa:MessageID>
        urn:uuid:78c1ba33-8b6b-48b4-9ea8-88effc609161
    </wsa:MessageID>
    <wsa:RelatesTo>
        urn:uuid:51cca63d-57a8-4990-97b1-66012a31e6a5
    </wsa:RelatesTo>
    <wsa:To>
        http://mmfp.tabs.toshiba.com/internetstorageservice/
    </wsa:To>
    <wsa:From>
      <wsa:Address>urn:uuid:38f1d51c-d44d-4978-9651-
2d72154a7a35</wsa:Address>
    </wsa:From>
    <wsc:CompressionAssertion>
      <wsc:compression name=“ZIP” crc=“9867588763209876”>
        <wsc:ratio>50</wsc:ratio>
        <wsc:algrithm>LDW-G3</wsc:algrithm>
      </wsc:compression>
    </wsc:CompressionAssertion>
    <wss:UsernameSecurityToken encrypted = “true”>
      ...
    </wss:UsernameSecurityToken>
  </SOAP-ENV:Header>
  <SOAP-ENV:Body>
    <wsdiscmap:Files>
      <wsdiscmap:file name=“test.doc” size=“546,789” encoding=“MTOM”>
        <wsdiscmap:fileid>uuid:35thd51c-a67d-8976-9651-
5r77104r8g32</wsdiscmap:fileid>
        <wsdiscmap:compression>ZIP</wsdiscmap:compression>
        <wsdiscmap:data>9745245kaf986341;347adrakrjqe8</wsdiscmap:data>
        <wsdiscmap:lastpiece>true</wsdiscmap:lastpiece>
      </wsdiscmap:file>
    </wsdiscmap:Files>
    <wsdiscmap:Destination>
      <wsdiscmap:renameTo>testtest.doc</wsdiscmap:renameTo>
      <wsdiscmap:folder>jason/test/</wsdiscmap:folder>
      <wsdiscmap:overwrite>true</wsdiscmap:overwrite>
      <wsdiscmap:diskfullalert>false</wsdiscmap:diskfullalert>
    </wsdiscmap:Destination>
    <wsdiscmap:Notification>
      <wsdiscmap:NotifyOn>Error Complete Aborted</wsdiscmap:NotifyOn>
      <wsdiscmap:NotifyTo>
        <wsa:Address>urn:uuid:38f1d51c-d44d-4978-9651-
2d72154a7a35</wsa:Address>
      </wsdiscmap:NotifyTo>
    </wsdiscmap:Notification>
  </SOAP-ENV:Body>
</SOAP-ENV:Envelope>
```

This SOAP message is then communicated via the computer network 102 to the remote storage device 110 or 120 by the client driver of the associated workstation 114. The workstation 114 then receives a response message in a web services communication protocol format representative of status data associated with the user login data. That is, the client driver of the workstation 114 receives data representing, for example and without limitation, storage capacity, storage utilization, remaining capacity, storage cost, elapsed storage time, file size, storage location, storage provider, or the like from the designated remote storage location 110 or 120. This status data is then propagated by the client driver to the user interface associated with the workstation 114, so as to inform the user as to the status of the user's account on the remote storage location 110 or 120. The skilled artisan will appreciate that the status data thereby indicates to the client driver whether the requested file operation is capable of being performed. For example, when the requested operation is a copy operation, the client driver receives a message from the remote storage location indicating that the user has exceeded the allotted, or purchased, storage capacity, thereby prompting the user to purchase more storage capacity or to free up storage capacity by moving or deleting one or more other files.

Further, in accordance with one example embodiment of the subject application, an authentication request is first received by a remote data storage device 110 or 120 via the computer network 102 from a workstation 114 or other suitable electronic device. Preferably, the authentication request includes login or identification data corresponding to an identification of a user. Thus, the login or identification data enables the controller 108 or storage server 118 to ascertain the account settings, e.g., storage capacities, associated with the user. Once the user is authenticated, preferably against a suitable database resident on the remote storage device 110 or 120 corresponding to authorized users, a username security token is generated by the controller 108 associated with the remote data storage device 110, the network storage server 118 associated with the remote data storage device 120, or other suitable network device, as will be understood by those skilled in the art.

The status associated with the user, as identified by the received identification data, is then determined by the controller 108, the network storage server 118, or the like. Preferably, this status corresponds to data representing storage capacity, storage utilization, remaining capacity, storage cost, elapsed storage time, file size, storage location, storage provider, or the like, with which the user is associated. Stated another way, the controller 108 or the storage server 118 determines how much storage is left, how much is the storage of files for the user costs, any payments due to the storage provider, or the like. The status and the security token are then communicated to the workstation 114, which originated the request, via the computer network 102. Preferably, this data is sent via a secure communications channel, using any suitable network security protocols known in the art. Suitable encryption algorithms are also capable of being employed in accordance with one embodiment of the subject application.

A file request is then received from the associated user via the workstation 114 by the remote storage location, i.e., the controller 108 associated with the data storage device 110 or the networks storage server 118 associated with the data storage device 120. The request received by the storage device 110 or 120 is then analyzed to determine the type of request. That is, the request is analyzed to determine whether the file operation of the request corresponds to a view operation, a copy operation, a move operation, a delete operation, a create operation, a rename operation, or the like. A determination is then made, following the designation of the type of file operation, whether or not the request is allowed. Stated another way, the storage location first determines, based upon the status data, whether or not the requested operation is capable of being performed, or if the user has exceeded the allotted storage, costs, storage time, file size, or the like.

When it has been determined that the requested file operation is not allowed, the user is prompted, via the user interface associated with the workstation 114, to rectify the denial. When no such action is undertaken by the user, the security token is invalidated by the remote storage location (controller 108 or storage server 118) and the connection between the client driver of the workstation 114 and the remote storage location (controller 108 or server 118) is terminated. It will be appreciated by those skilled in the art that the invalidation of the security token is accomplished via any means known in the art by the remote storage location (controller 108 or server 118). Thus, it will be understood that upon invalidation of the security token, the workstation 114 must first procure a new security token for any subsequent operations with respect to the remote storage location (controller 108 or server 118). When the user has rectified the denial, or when the original determination allows the requested operation, the remote data storage device 110 or 120 performs the requested file operation and returns the results to the requesting workstation. Preferably, this return of the results is accomplished using a web services communication protocol format, such as, for example and without limitation, a SOAP message format, which is then used by the client driver to modify the operating system of the workstation 114 to reflect the performance of the requested file operation. As will be understood by those skilled in the art, the SOAP message format is preferably an XML message containing a response to the requested file operation that is understood by the client driver of the workstation 114. Suitable file operation instructions include, for example and without limitation, a view operation, a copy operation, a move operation, a delete operation, a create operation, a rename operation, or the like. An example XML SOAP message responding to a copy operation is illustrated below:

```
<?xml version=“1.0” encoding=“UTF-8”?>
<SOAP-ENV:Envelope xmlns:SOAP-ENV=“http://www.w3.org/2003/05/soap-
envelope”
          xmlns:SOAP-ENC=“http://www.w3.org/2003/05/soap-encoding”
          xmlns:xsi=“http://www.w3.org/2001/XMLSchema-instance”
          xmlns:xsd=“http://www.w3.org/2001/XMLSchema”
xmlns:wsdiscmap=“http://schemas.toshiba.com/ws/2006/08/webdiscmapping”
          xmlns:wss=“http://schemas.xmlsoap.org/ws/2005/08/Security”
          xmlns:wsa=“http://schemas.xmlsoap.org/ws/2004/08/Address”
xmlns:wsr=“http://schemas.xmlsoap.org/ws/2004/09/ReliableMessaging”>
  <SOAP-ENV:Header>
    <wsa:Action>
http://schemas.toshiba.com/windows/2006/08/webdiskmapping/CopyResponse
    </wsa:Action>
    <wsa:MessageID>
        urn:uuid:51bbc56e-8i76-0987-65t6-76876b71e3b8
    </wsa:MessageID>
    <wsa:RelatesTo>
        urn:uuid:78c1ba33-8b6b-48b4-9ea8-88effc609161
    </wsa:RelatesTo>
    <wsa:To>
        urn:uuid:38f1d51c-d44d-4978-9651-2d72154a7a35
    </wsa:To>
    <wsa:From>
<wsa:Address>http://mmfp.tabs.toshiba.com/internetstorageservice</wsa:Address>
    </wsa:From>
      ...
    </wss:UsernameSecurityToken>
  </SOAP-ENV:Header>
  <SOAP-ENV:Body>
    <wsdiscmap:Files>
      <wsdiscmap:file name=“test.doc” size=“546,789”>
        <wsdiscmap:fileid>uuid:35thd51c-a67d-8976-9651-
5r77104r8g32</wsdiscmap:fileid>
        <wsdiscmap:compression>ZIP</wsdiscmap:compression>
<wsdiscmap:completedtime>08/21/2006:14:23:08:987654</wsdiscmap:startat>
        <wsdiscmap:renameTo>testtest.doc</wsdiscmap:renameTo>
        <wsdiscmap:copiedTo>jason/test</wsdiscmap:copiedTo>
        <wsdiscmap:status>completed</wsdiscmap:status>
        <wsdiscmap:notifiedTo>urn:uuid:38f1d51c-d44d-4978-9651-
2d72154a7a35</wsdiscmap:notifiedTo>
...
<wsdiscmap:notifiedTime>08/21/2006:14:23:09:564328</wsdiscmap:notifiedTime>
      </wsdiscmap:file>
    </wsdiscmap:Files>
  </SOAP-ENV:Body>
      </SOAP-ENV:Envelope>
```

When additional requests are received from the workstation 114, the remote data storage device 110 or 120 performs the requested operations until such time as the requests are no longer allowed, a disconnect request is received, or no longer received. When one of these conditions arises, the security token is invalidated and the connection between the remote data storage device 110 or 120 and the workstation 114 is terminated.

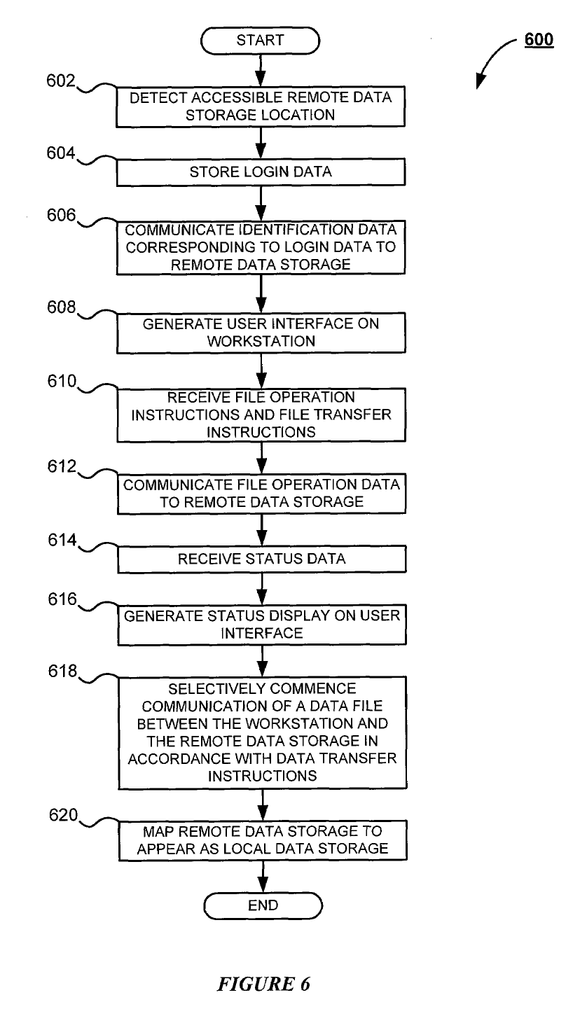

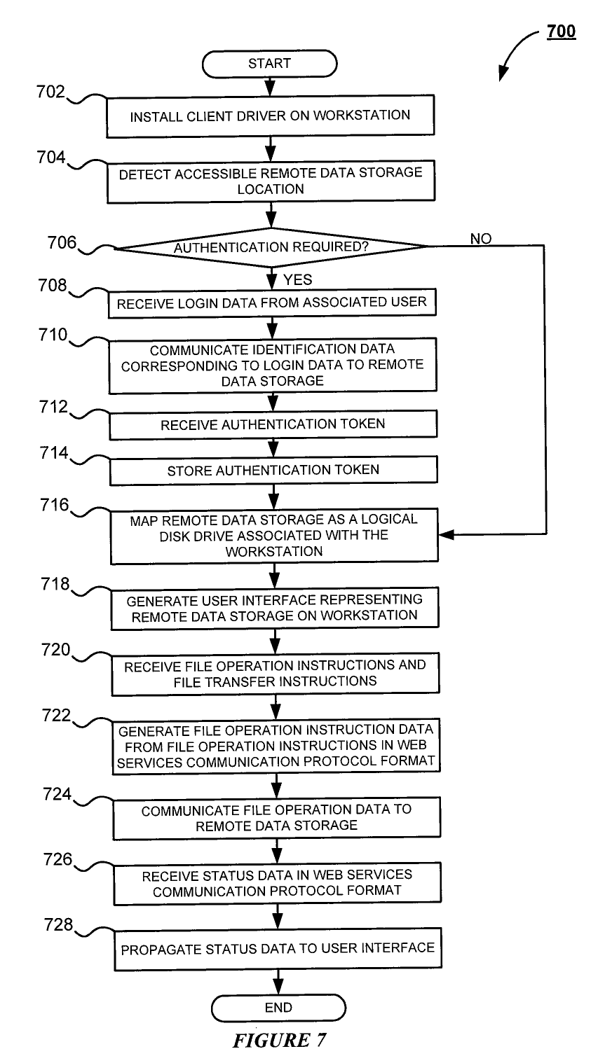

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for integration of web-based storage to a local operating system graphical user interface in accordance with one embodiment of the subject application. Beginning at step 602, a workstation first detects, via a suitable network interface, at least one remote data storage location communicatively coupled to the computer network 102. At step 604 login data corresponding to access of the remote data storage is stored. In accordance with one embodiment of the subject application, the login data corresponds to identification data which is required by the remote data storage in order for the workstation 114 to communicate therewith. The login data, corresponding to the login data to the remote data storage, is then communicated to the remote data storage at step 606.

A user interface, corresponding to the remote data storage, is then generated on a display window associated with the workstation 114 at step 608. At step 610, file operation instructions and file transfer instructions are received from an associated user via a generated user interface. Preferably, the instructions are received via a user interface generated on the workstation 114. Suitable operations include, for example and without limitation, view, copy, move, delete, create, rename, and the like. File operation data corresponding to received file operation instructions is then communicated to the remote data storage at step 612. The workstation 114, via the associated network interface, then receives status data from the remote data storage at step 614. As will be appreciated by those skilled in the art, the status data is capable of including, for example and without limitation, storage capacity, storage utilization, remaining capacity, storage cost, elapsed storage time, file size, storage location, storage provider, or the like. At step 616, a status display is generated on the user interface of the associated workstation 114.

Communication is then selectively commenced at step 618 corresponding to the communication of a data file between the workstation 114 and the remote data storage (e.g., data storage device 110 or data storage device 120) in accordance with data transfer instructions received via the user interface. At step 620, the remote data storage is mapped so as to appear as a local data storage device, i.e., to appear as a data storage local to the workstation 114. In accordance with one embodiment of the subject application, the file operation instructions and/or the file transfer instructions are integrated so as to interact with the user interface associated with the operating system of the workstation 114, such that the remote data storage appears as a local storage associated with the workstation 114.

Referring now to FIG. 7, there is shown a flowchart 700 illustrating a method for integration of web-based storage to a local operating system graphical user interface from a workstation perspective in accordance with one embodiment of the subject application. The embodiment described in FIG. 7 begins at step 702, wherein a client driver is installed on the workstation 114 via any suitable means known in the art for installation of drivers. Preferably, the driver installed on the workstation 114 is compatible with the operating system disposed thereon. At step 704, the workstation 114, via the client driver, detects at least one accessible remote data storage location, e.g., the data storage location represented by the document processing device 104 data storage device 110, the network storage server 118 data storage device 120, or the like. A determination is then made by the client driver at step 706 whether authentication is required to access the remote data storage. The skilled artisan will appreciate that such a determination reflects whether a security token for the remote data storage is already stored in memory local to the workstation 114, or if no such security token is required for access to the remote data storage. When authentication is required, and no security token has previously been stored, flow proceeds to step 708, whereupon the client driver, via the user interface associated with the workstation 114, receives login data from an associated user. Preferably, the login data includes data representative of a username, password, alphanumeric sequence, biometric data, account number, or other indicia of the identity and authority of the user.

Identification data, inclusive of the login data, is then communicated to the remote storage device 110 or 120 via the computer network 102 at step 710. In accordance with one embodiment of the subject application, the transmission of the identification data is capable of being accomplished using a secure network communications protocol, an encrypted format, or other secure method of communication over the computer network 102. At step 712 the client driver, via the workstation 114, receives an authentication security token corresponding to the remote data storage device 110 or 120. The received security token is then stored at step 714 in storage local to the workstation 114. Thus, the skilled artisan will appreciate that security token is made available for future transactions with the associated remote data storage device 110 or 120, obviating the need to receive the login data from the associated user for each transaction.

The remote storage device 110 or 120 is then mapped as a logical disk drive associated with the workstation 114 by the client driver at step 716. The skilled artisan will appreciate that the client driver thereby instructs the operating system disposed on the workstation 114 to view the remote data storage device 110 or 120 as a local disk even though the remote storage device 110 or 120 is being accessed via the computer network 102. At step 718, a user interface is generated on the workstation 114, representing the remote data storage device 110 or 120.

File operation instructions and/or file transfer instructions are then received by the client driver at step 720 via the user interface associated with the workstation 114. The client driver then generates, at step 722, file operation instruction data from the file operation instructions in web services communication protocol format. Preferably, the format employed by the client driver is an XML SOAP message format, readily understandable by the remote data storage device 110 or 120. The file operation data is then communicated, via the computer network 102, to the remote data storage device 110 or 120 at step 724. At step 726, the client driver, via the network interface of the workstation 114, receives status data in web services communication protocol format from the remote storage device 110 or 120. Preferably, the status data represents the current status of the remote storage device 110 or 120 with respect to the user identified by the identification data. Thus, as will be appreciated by those skilled in the art, the status data includes, for example and without limitation, storage capacity, storage utilization, remaining capacity, storage cost, elapsed storage time, file size, storage location, storage provider, and the like. The received status data is then propagated to the user interface of the workstation 114 at step 728. The skilled artisan will appreciate that such a propagation enables the user to view the total amount of storage capacity on the remote storage, the storage utilization, the capacity remaining available to the user, the costs associated with the current or additional storage capacity, who is providing the storage services, how long the data is stored, any limitations on file size, or the like. The skilled artisan will further appreciate that such a display also enables the user to purchase additional storage capacity, storage time, search for additional storage providers, or the like.

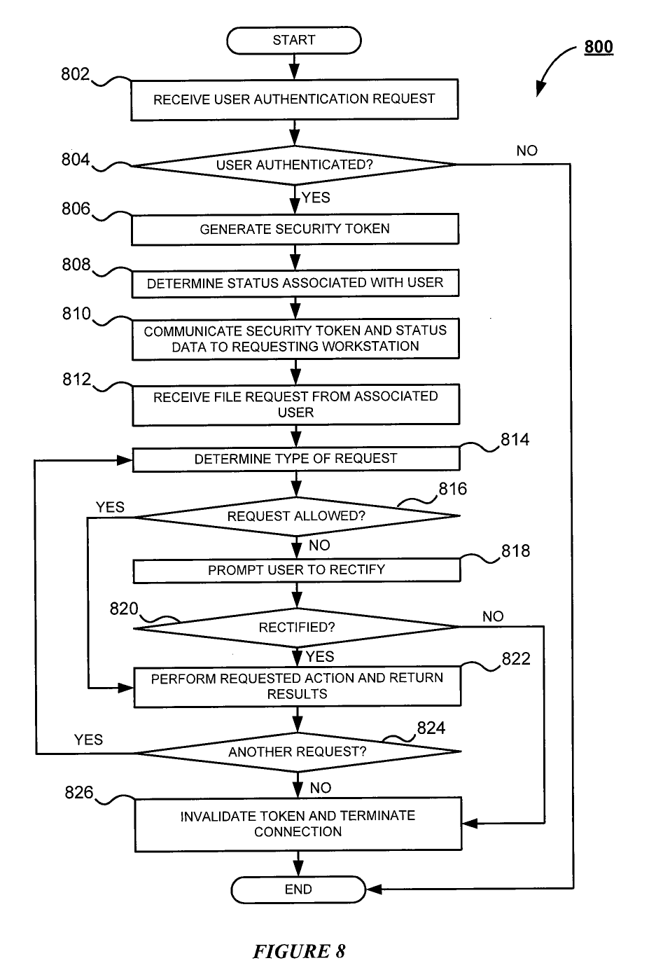

Turning now to FIG. 8, there is shown a flowchart 800 illustrating a method for integration of web-based storage to a local operating system graphical user interface from a storage perspective in accordance with one embodiment of the subject application. The embodiment depicted in FIG. 8 begins at step 802, wherein a remote storage device 110 or 120 receives a user authentication request via the computer network 102. Preferably, the authentication request includes identification data representing the identity of an associated user, the originating workstation 114, login data, or the like. Suitable login data includes, for example and without limitation, a username, password, alphanumeric sequence, biometric data, account number, or the like. For purposes of explanation of FIG. 8 only, reference is made herein to the storage server 118 and associated storage device 120. The skilled artisan will appreciate that the methodology of FIG. 8 is equally applicable to any network storage, e.g., the controller 108/data storage device 110 of the networked document processing device 104, or other storage device coupled to the computer network 102. A determination is then made at step 804 whether the user, as identified by the authentication request is authorized. In accordance with one embodiment of the subject application, the remote storage device 120 includes a database inclusive of user identification data and authority levels, thereby enabling the determination of rights associated with the user, capacity purchased, capacity used, and the like. In accordance with another embodiment of the subject application, the user is authenticated via a dedicated authentication server (not shown), which stores authentication data representing a plurality of users of the storage device 120, and against which a user is capable of being authenticated. When the user is not authorized, e.g., an invalid username/password, or the like, the connection is terminated.

Once the user has been authenticated, flow proceeds to step 806, whereupon the remote storage device 120 generates a security token, as will be understood by those skilled in the art. Status data associated with the user is then determined at step 808 corresponding to the current status of the remote storage device 120 with respect to the identified user. It will be appreciated by those skilled in the art that when multiple remote storage devices, e.g., 110 and 120, are employed by a storage service provider, the status data is capable of including the total storage usage associated with the user, i.e., data on both the data storage device 110 and the data storage device 120. At step 810, the security token and the status data are communicated to the requesting workstation 114 via the computer network 102. As will be appreciated by those skilled in the art, the data transmitted to the workstation 114 via the computer network 102 is capable of being transmitted using a secure network communications protocol format, an encrypted format, or any suitable combination thereof to prevent unauthorized or unanticipated interception of the data.

A file request is then received from the associated user at step 812 representative of a desired file operation to be performed by the remote data storage device 120. The type of file operation request is then determined at step 814 by the remote data storage device 120. As will be understood by those skilled in the art, suitable file operations include, for example and without limitation, a copy operation, a move operation, a delete operation, a rename operation, a create operation, or the like. The remote storage device 120 then determines, at step 816, whether the requested file operation is allowed. That is, the device 120 first determines whether the user, or the user's account, authorizes the performance of the requested file operation. For example, when the user has exceeded the maximum file size, the maximum storage capacity, the allotted storage time, or the like, the request is denied. When it is determined at step 816 that the requested operation is not allowed, the user is prompted, via a communication to the workstation 114, to rectify the denial. Such rectification includes, for example and without limitation, the purchase of additional storage capacity or time, the deletion of one or more previously stored files, the de-selection of a file exceeding the maximum file size, or the like.

A determination is then made at step 820 whether the user has rectified the denial of performance. When no such rectification is found by the remote storage device 120, the security token is invalidated and the connection between the workstation 114 and the storage device 120 is terminated. When the denial has been rectified, or when the request is determined to be allowed, such as at step 816, flow proceeds to step 822, whereupon the remote storage device 120 performs the requested file operation and returns the results to the requesting workstation 114. A determination is then made at step 824 whether another request has been received by the remote data storage 120 from the workstation 114. When such a request has been received, flow returns to step 814, whereupon the type of file operation requested is determined. When no such additional request is received, or when a disconnect request is received by the remote storage device 120, flow proceeds to step 826, whereupon the security token is invalidated and the connection between the workstation 114 and the remote storage device 120 is terminated.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for integration of web-based storage to a local operating system graphical user interface comprising:
a driver adapted for installation on an associated workstation, the driver including,
means adapted for detecting availability of at least one remote data storage location accessible to the associated workstation via an associated network interface,
means adapted for storing login data corresponding to access of the at least one remote data storage,
means adapted for communicating identification data corresponding to the login data to the at least one remote data storage so as to allow data interchange therewith,
means adapted for generating a user interface corresponding to the at least one remote data storage on a display window of the associated workstation;
means adapted for receiving from an associated user, via a generated user interface, file operation instructions and file transfer instructions,
means adapted for communicating file operation data corresponding to received file operation instructions to the at least one remote data storage,
means adapted for receiving status data from the at least one remote data storage via the associated network interface,
means adapted for generating status display data corresponding to received status data on the user interface, and
means adapted for selectively commencing a communication of at least one data file between the associated workstation and the at least one remote data storage in accordance with data transfer instructions received via the user interface; and
mapping means adapted for mapping the at least one remote data storage location so as to appear as a local data storage;
wherein at least one of file operation instructions and file transfer instructions are integrated so as to interact with a user interface associated with an operating system disposed on the associated workstation such that the at least one remote data storage appears to be a local storage associated with the workstation.

2. The system for integration of web-based storage to a local operating system graphical user interface of claim 1 wherein the driver further comprises:
means adapted for generating the file operation instruction data from received file operation instructions in web services communication protocol format; and
means adapted for receiving the status data in web services communication protocol format.

3. The system for integration of web-based storage to a local operating system graphical user interface of claim 2 wherein the file operation instructions include at least one operation from the set comprising view, copy, move, delete, create and rename.

4. The system for integration of web-based storage to a local operating system graphical user interface of claim 3 wherein the web services communication protocol format is a SOAP format.

5. The system for integration of web-based storage to a local operating system graphical user interface of claim 4 wherein the mapping means includes means adapted for mapping the at least one remote data storage as a logical disk drive associated with the workstation.

6. The system for integration of web-based storage to a local operating system graphical user interface of claim 5 wherein the status data includes data representative of at least one data from the set comprising storage capacity, storage utilization, remaining capacity, storage cost, elapsed storage time, file size, storage location and storage provider.

7. A method for integration of web-based storage to a local operating system graphical user interface comprising the steps of:
detecting availability of at least one remote data storage location accessible to an associated workstation via an associated network interface;
storing login data corresponding to access of the at least one remote data storage;
communicating identification data corresponding to the login data to the at least one remote data storage so as to allow data interchange therewith;
generating a user interface corresponding to the at least one remote data storage on a display window of the associated workstation;
receiving from an associated user, via a generated user interface, file operation instructions and file transfer instructions;
communicating file operation data corresponding to received file operation instructions to the at least one remote data storage;
receiving status data from the at least one remote data storage via the associated network interface;
generating status display data corresponding to received status data on the user interface;
selectively commencing a communication of at least one data file between the associated workstation and the at least one remote data storage in accordance with data transfer instructions received via the user interface; and
mapping the at least one remote data storage location so as to appear as a local data storage;
wherein at least one of file operation instructions and file transfer instructions are integrated so as to interact with a user interface associated with an operating system disposed on the associated workstation such that the at least one remote data storage appears to be a local storage associated with the workstation.

8. The method for integration of web-based storage to a local operating system graphical user interface of claim 7 further comprising the steps of:
generating the file operation instruction data from received file operation instructions in web services communication protocol format; and
receiving the status data in web services communication protocol format.

9. The method for integration of web-based storage to a local operating system graphical user interface of claim 8 wherein the file operation instructions include at least one operation from the set comprising view, copy, move, delete, create and rename.

10. The method for integration of web-based storage to a local operating system graphical user interface of claim 9 wherein the web services communication protocol format is a SOAP format.

11. The method for integration of web-based storage to a local operating system graphical user interface of claim 10 wherein the step of mapping includes mapping the at least one remote data storage as a logical disk drive associated with the workstation.

12. The method for integration of web-based storage to a local operating system graphical user interface of claim 11 wherein the status data includes data representative of at least one data from the set comprising storage capacity, storage utilization, remaining capacity, storage cost, elapsed storage time, file size, storage location and storage provider.

13. A computer-implemented method for integration of web-based storage to a local operating system graphical user interface comprising the steps of:
detecting availability of at least one remote data storage location accessible to an associated workstation via an associated network interface;
storing login data corresponding to access of the at least one remote data storage;
communicating identification data corresponding to the login data to the at least one remote data storage so as to allow data interchange therewith;
generating a user interface corresponding to the at least one remote data storage on a display window of the associated workstation;
receiving from an associated user, via a generated user interface, file operation instructions and file transfer instructions;
communicating file operation data corresponding to received file operation instructions to the at least one remote data storage;
receiving status data from the at least one remote data storage via the associated network interface;
generating status display data corresponding to received status data on the user interface;
selectively commencing a communication of at least one data file between the associated workstation and the at least one remote data storage in accordance with data transfer instructions received via the user interface; and
mapping the at least one remote data storage location so as to appear as a local data storage;
wherein at least one of file operation instructions and file transfer instructions are integrated so as to interact with a user interface associated with an operating system disposed on the associated workstation such that the at least one remote data storage appears to be a local storage associated with the workstation.

14. The computer-implemented method for integration of web-based storage to a local operating system graphical user interface of claim 13 further comprising the steps of:
generating the file operation instruction data from received file operation instructions in web services communication protocol format; and
receiving the status data in web services communication protocol format.

15. The computer-implemented method for integration of web-based storage to a local operating system graphical user interface of claim 14 wherein the file operation instructions include at least one operation from the set comprising view, copy, move, delete, create and rename.

16. The computer-implemented method for integration of web-based storage to a local operating system graphical user interface of claim 15 wherein the web services communication protocol format is a SOAP format.

17. The computer-implemented method for integration of web-based storage to a local operating system graphical user interface of claim 16 wherein the step of mapping includes mapping the at least one remote data storage as a logical disk drive associated with the workstation.

18. The computer-implemented method for integration of web-based storage to a local operating system graphical user interface of claim 17 wherein the status data includes data representative of at least one data from the set comprising storage capacity, storage utilization, remaining capacity, storage cost, elapsed storage time, file size, storage location and storage provider.
